(19) United States
(12) Patent Application Publication
(10) Pub. No.: US 2004/0180628 A1
(43) Pub. Date: Sep. 16, 2004

(54) Communication module and transceiver integrated circuit

(75) Inventors: Shohei Moriwaki, Tokyo (JP); Yoshifumi Azekawa, Tokyo (JP); Osamu Chiba, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Renesas Technology Corp., TOKYO (JP)

(21) Appl. No.: 10/679,461

(22) Filed: Oct. 7, 2003

(30) Foreign Application Priority Data
Mar. 13, 2003 (JP) 2003-67890

(51) Int. Cl. H04B 1/38

(52) U.S. Cl. 455/73

(57) ABSTRACT

A bus (3) includes a data bus (3a) and a clock bus (3b). The data bus (3a) is used for propagation of data MDIO conforming to the MDIO interface standards performed between a host controller IC (40) and a transceiver IC (1), and for propagation of data (SDA) conforming to the I²C standards performed between the transceiver IC (1) and a peripheral IC (2). Meanwhile, the clock bus (3b) is used for propagation of clock (MDC) conforming to the MDIO interface standards performed between the host controller IC (40) and the transceiver IC (1), and for propagation of clock (SCL) conforming to the I²C standards performed between the transceiver IC (1) and the peripheral IC (2).

### BACKGROUND OF THE INVENTION

1. Field of the Invention

This invention relates to transceivers equipped in communication modules which are connected to each other via a bus. For example, this invention is preferably applied to the transceivers conforming to IEEE802.3ae standards.

2. Description of the Background Art

The communication modules, mutually connected via a bus, generally include a transmitter-receiver, a transceiver IC having a predetermined register, and a peripheral IC accessing this register.

The peripheral IC, connected to the transmitter-receiver, controls the transmitter-receiver. The transceiver IC has an arrangement, for example, conforming to the IEEE802.3ae standards. In this case, the register in the transceiver IC is connected to the peripheral IC via a bus conforming to I²C (Inter IC) standards which is capable of serving as a utility bus (hereinafter, referred to ‘I²C bus’). The I²C bus used in this case is for example disclosed in “THE I2C-BUS SPECIFICATION VERSION 2.1”, [online], JANUARY 2000, Philips Semiconductor, [searched Jan. 21, 2003], Internet <http://www-us.semiconductors.philips.com/acrobat/various/I2C_BUS_SPECIFICATIO N_{—}3.pdf> (hereinafter, referred to as non-patent document). The transceiver IC is connected to a host controller IC which is employed according to the IEEE802.3ae standards for controlling a plurality of transceiver ICs. The transceiver IC and the host controller IC are connected to each other via a bus serving as a system utility bus conforming to MDIO (Management Data Input/Output) interface standards employed in the IEEE802.3ae standards. Hereinafter, this system utility bus is referred to as “MDIO bus.”

Japanese Patent Application Laid-open No. 2001-251328 discloses a technique for allowing an external multi-port Ethernet (trademark) transceiver apparatus, such as an Ethernet (trademark) integrated circuit, to utilize an internal status signal via a common status signal bus.

Furthermore, Japanese Patent Application Laid-open No. 11-85673(1999) discloses a technique for enabling the devices connected to the common bus to perform high-speed and random access even if they have mutually different bus protocols.

However, according to the internal arrangement of conventional communication modules, dedicated terminals and wiring are allocated independently for each of the I²C bus and the MDIO bus which respectively adopt different communication modes. In this respect, the communication functions are independently realized. Accordingly, the wiring area required in the communication module is large.

### SUMMARY OF THE INVENTION

It is an object of the present invention to reduce the wiring area and also to reduce the terminals to be provided on a transceiver IC.

A communication module of the present invention includes a clock bus, a transceiver integrated circuit, and a peripheral integrated circuit. First and second clocks propagate exclusively via the clock bus. The first and second clocks respectively conform to first and second standards which are mutually different in clock frequency, in bus arbitration, and in protocol type. First data conforming to the first standard propagate between the transceiver integrated circuit and an upper layer. Second data conforming to the second standard propagate between the peripheral integrated circuit and the transceiver integrated circuit.

There is no necessity of providing independent terminals and wiring dedicated to propagating each of the first and second clocks. Thus, the wiring area required in the communication module can be reduced.

A first transceiver integrated circuit of the present invention includes first and second functional blocks, a clock pad, and first and second clock lines. The first and second functional blocks realize interfaces respectively conforming to first and second standards which are mutually different in clock frequency, in bus arbitration, and in protocol type. The first clock line is connected between the clock pad and the first functional block. The first clock propagates via the first clock line. The second clock line is connected between the clock pad and the second functional block. The second clock propagates via the second clock line. The first and second clocks conform to the first and second standards, respectively.

A second transceiver integrated circuit of the present invention includes first and second functional blocks, a clock lead frame, first and second clock pads, first and second clock lines, and first and second wires. The first and second functional blocks realize interfaces respectively conforming to first and second standards which are mutually different in clock frequency, in bus arbitration, and in protocol type. The first clock line is connected between the first clock pad and the first functional block. The first clock propagates via the first clock line. The second clock line is connected between the second clock pad and the second functional block. The second clock propagates via the second clock line. The first wire connects the clock lead frame to the first clock pad. The second wire connects the clock lead frame to the second clock pad. The first and second clocks conform to the first and second standards, respectively.

There is no necessity of providing independent terminals and wiring dedicated to propagating each of the first and second clocks. Thus, it becomes possible to reduce the wiring area required in the communication module equipped with the first or second transceiver integrated circuit.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a first embodiment of the present invention;

FIG. 2 is a block diagram showing a second embodiment of the present invention;

FIG. 3 is a block diagram showing a third embodiment of the present invention; and

FIG. 4 is a block diagram showing a fourth embodiment of the present invention.

### DESCRIPTION OF THE PREFERRED EMBODIMENTS

First Embodiment

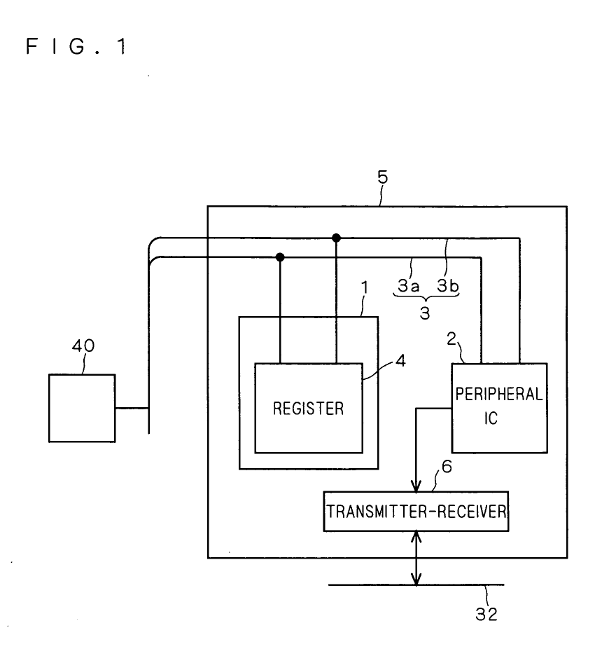

FIG. 1 is a block diagram showing a first embodiment of the present invention. An optical communication module 5 includes a transceiver IC 1, a peripheral IC 2, and a transmitter-receiver 6. The optical communication module 5 functions, for example, as an Ethernet (trademark) transceiver module.

The transceiver IC 1 includes a register 4. The register 4 is connected to the peripheral IC 2 via a bus 3. A host controller IC 40, provided outside the optical communication module 5, is connected to the register 4 via the bus 3.

The transmitter-receiver 6 is connected to an external device via an optical cable 32 to perform transmitting/receiving function. To control the operation of transmitter-receiver 6, the peripheral IC 2 transmits and receives information to and from the transmitter-receiver 6.

The bus 3 includes a data bus 3a and a clock bus 3b. The data bus 3a is commonly used for propagation of data MDIO which conforms to the MDIO interface standards and is performed between the host controller IC 40 and the transceiver IC 1, and for propagation of data SDA which conforms to the I²C standards and is performed between the transceiver IC 1 and the peripheral IC 2. Meanwhile, performed on the clock bus 3b is propagation of clock MDC which conforms to the MDIO interface standards and is performed between the host controller IC 40 and the transceiver IC 1 as well as propagation of clock SCL which conforms to the I²C standards and is performed between the transceiver IC 1 and the peripheral IC 2.

The use of bus according to the MDIO interface standards is different from the use of bus according to the I²C standards in clock frequency, in bus arbitration, and in protocol type. Furthermore, in respective standards, the condition of a clock signal line is confirmed first and then a clock is generated to acquire a bus mastership only when this signal line is not used.

According to the MDIO interface standards, for example, stipulated in the chapter 45.3.2 of IEEE802.3ae, a 32-cycle preparation clock called as ‘Preamble’ is sent out to the clock signal line. The generation of this preparation clock has an effect of notifying transmitting own data to other circuits connected to the same clock signal line. According to the I²C standards, the system being unique and fundamentally different from the above-described ‘Preamble’ is employed for bus arbitration.

Accordingly, when the clock SCL is propagating between the transceiver IC 1 and the peripheral IC 2, the clock bus 3b cannot be used for the communication conforming to the MDIO interface standards. Namely, when the clock SCL is propagating via the clock bus 3b, the clock MDC does not disturb the clock SCL. Accordingly, the bus mastership is given to the communication conforming to the I²C standards. The data MDIO does not propagate via the data bus 3a.

Furthermore, when the clock MDC is propagating, the clock frequency of the clock MDC is extremely different from that of the clock SCL. Accordingly, when the clock MDC is propagating between the host controller IC 40 and the transceiver IC 1, the clock bus 3b cannot be used for the communication conforming to the I²C standards because it is difficult to obtain the sequence of START signal generation/Slave address transfer/Data transfer/STOP signal generation according to the I²C standards (for example, refer to the chapter 8 of the above-mentioned non-patent document). Namely, when the clock MDC is propagating via the clock bus 3b, the clock SCL does not disturb the clock MDC. Accordingly, the bus mastership is given to the communication conforming to the MDIO interface standards. The data SDA does not propagate via the data bus 3a. As understood from the foregoing description, the clock bus 3b allows each of the clock SCL and the clock MDC to propagate in such a manner that the clock SCL and the clock MDC propagate exclusively. Furthermore, even when the data bus 3a is commonly used for propagating the data SDA and MDIO, they do not disturb each other.

When none of the clock MDC and the clock SCL are propagating, the clock bus 3b is given an electric potential equivalent to a logic “H” in either case of conforming to the MDIO interface standards or conforming to the I²C standards.

As apparent from the foregoing description, the propagation of data MDIO and clock MDC conforming to the MDIO interface standards and the propagation of data SDA and clock SCL conforming to the I²C standards do not disturb each other on the bus 3. In this manner, according to this embodiment, a pair of data bus 3a and clock bus 3b can be used for the propagation of data and clock conforming to both of the MDIO interface standards and the I²C standards. There is no necessity of providing independent terminals and wiring dedicated to each of the I²C bus and the MDIO bus. Thus, it becomes possible to reduce the wiring area required in the optical communication module 5.

In a case where the clock MDC and clock SCL take mutually different electric potentials so as to realize the binary logic, it is preferable that the input/output levels of the transistors provided at the input/output stages of the transceiver IC 1 and the peripheral IC 2 are adjusted to match with a lower level of these different electric potentials, while the port withstand voltages at the input/output stages of the transceiver IC 1 and the peripheral IC 2 are adjusted to match with a higher level of these different electric potentials. The similar adjustment is preferable applicable in a case where the data MDIO and data SDA take mutually different electric potentials so as to realize the binary logic.

Second Embodiment

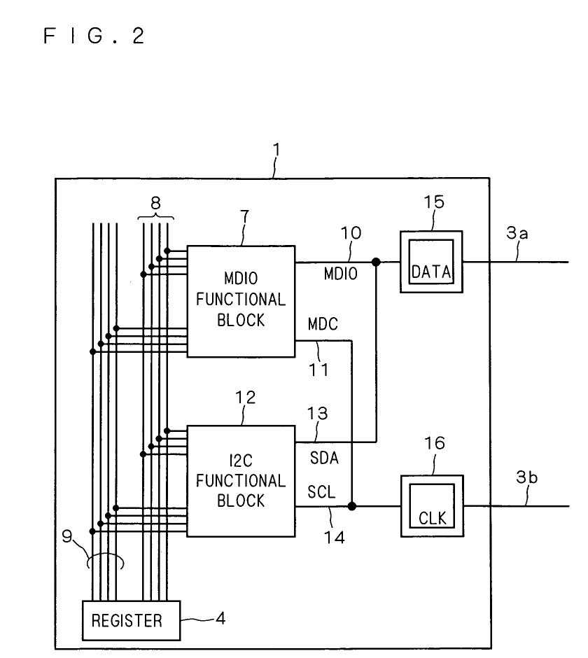

FIG. 2 is a block diagram showing a second embodiment of the present invention, which is employable as the transceiver IC 1 shown in the first embodiment.

In addition to the above-described register 4, the transceiver IC 1 includes a data bus 8, an address bus 9, an MDIO functional block 7 which realizes an MDIO interface, an I²C functional block 12 which realizes an interface conforming to I²C standards, data lines 10 and 13, clock lines 11 and 14, a data pad 15, and a clock pad 16.

The data bus 8 and the address bus 9 provide interconnection among the register 4, the MDIO functional block 7, and the I2C functional block 12, for propagation of the data stored in the register 4 together with their addresses.

The data line 10 and the clock line 11 are respectively connected to the MDIO functional block 7. The data MDIO propagates via the data line 10, while the clock MDC propagates via the clock line 11. The data line 13 and the clock line 14 are respectively connected to the I2C functional block 12. The data SDA propagates via the data line 13, while the clock SCL propagates via the clock line 14. The data lines 10 and 13 are commonly connected to the data pad 15. The clock lines 11 and 14 are commonly connected to the clock pad 16.

The data pad 15 is connected to the data bus 3a, while the clock pad 16 is connected to the clock bus 3b.

As apparent from the foregoing description, the transceiver IC 1 has an internal arrangement for connecting the data lines 10 and 13 to the data pad 15. Furthermore, the transceiver IC 1 has an internal arrangement for connecting the clock lines 11 and 14 to the clock pad 16. According to this arrangement, there is no necessity of providing independent terminals dedicated to each of the I²C interface and the MDIO interface. The constituent elements for the transceiver IC 1 can be reduced. Thus, it becomes possible to reduce the wiring area required in the optical communication module 5.

The transceiver IC 1 shown in the second embodiment can be manufactured as a chip. In this case, it is possible to connect lead frames via wires to the data pad 15 and the clock pad 16.

Third Embodiment

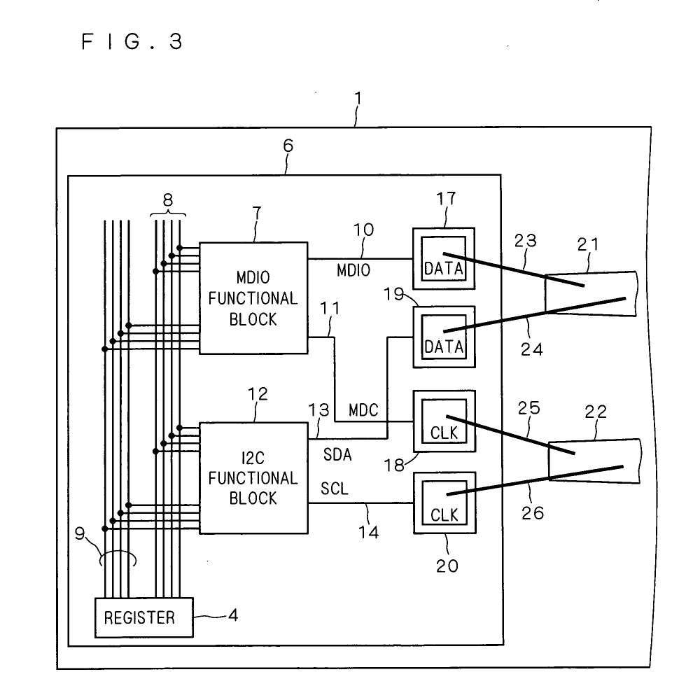

FIG. 3 is a block diagram showing a third embodiment of the present invention, which is employable as the transceiver IC 1 shown in the first embodiment.

The transceiver IC 1 is configured into a packaged body including a chip 6 and associated terminals, such as lead frames 21 and 22, connected to the chip 6. The transceiver IC 1 further includes wires 23 and 24 connected to the lead frame 21 and wires 25 and 26 connected to the lead frame 22 which are also packaged.

Like the transceiver IC 1 shown in the second embodiment, the chip 6 includes the register 4, the data bus 8, the address bus 9, the MDIO functional block 7, the I2C functional block 12, the data lines 10 and 13, and the clock lines 11 and 14. The functions performed by these components are identical with those shown in the second embodiment.

The chip 6 has two data pads 17 and 19, not the single data pad 15 shown in FIG. 2. Similarly, the chip 6 has two clock pads 18 and 20, not the single clock pad 16 shown in FIG. 2. The data line 10 transmitting data MDIO is connected to the data pad 17. The data line 13 transmitting data SDA is connected to the data pad 19. The clock MDC is given to the clock pad 18. And, the clock SCL is given to the clock pad 20.

The wires 23 and 24 are connected to the data pads 17 and 19, respectively. The wires 25 and 26 are connected to the clock pads 18 and 20, respectively. Namely, the third embodiment can be construed as having the data lines 10 and 13 mutually connected via the wires 23 and 24 and also having the clock lines 11 and 14 mutually connected via the wires 25 and 26.

As described above, the wires 23 and 24 are connected to the lead frame 21. The data bus 3a shown in FIG. 1 can be connected to the lead frame 21. Hence, there is no necessity of providing the external wiring dedicated to each of the I²C interface and the MDIO interface. Thus, it becomes possible to reduce the wiring area required in the optical communication module 5. Similarly, the clock bus 3b can be connected to the lead frame 22. Hence, it becomes possible to reduce the wiring area required in the optical communication module 5.

Fourth Embodiment

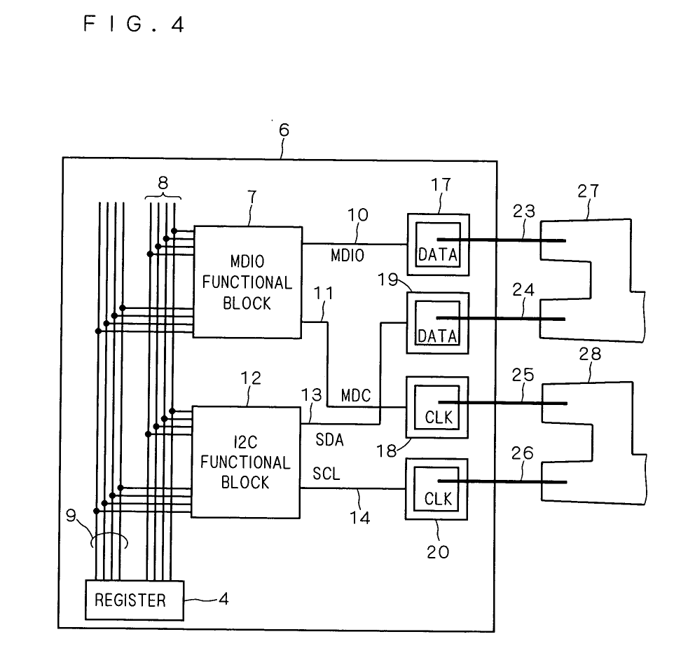

FIG. 4 is a block diagram showing a fourth embodiment of the present invention, which is employable as the transceiver IC 1 shown in the first embodiment. The fourth embodiment is structurally different from the third embodiment in that the lead frames 21 and 22 are replaced with lead frames 27 and 28, respectively. The lead frame 27 has bifurcated tips. The wire 23 is connected to one of the bifurcated tips of the lead frame 27. The wire 24 is connected to the other of the bifurcated tips of the lead frame 27. Furthermore, the lead frame 28 has bifurcated tips. The wire 25 is connected to one of the bifurcated tips of the lead frame 28. The wire 26 is connected to the other of the bifurcated tips of the lead frame 28.

Namely, the fourth embodiment can be construed as having the lead frame 27 connecting both of the data lines 10 and 13 via two wires 23 and 24 as well as the lead frame 28 connecting both of the clock lines 11 and 14 via two wires 25 and 26.

Accordingly, like the third embodiment, there is no necessity of providing the external wiring dedicated to each of the I²C interface and the MDIO interface. Thus, it becomes possible to reduce the wiring area required in the optical communication module 5.

While the invention has been shown and described in detail, the foregoing description is in all aspects illustrative and not restrictive. It is therefore understood that numerous other modifications and variations can be devised without departing from the scope of the invention.

What is claimed is:

1. A communication module, comprising:
a clock bus via which first and second clocks propagate exclusively, said first and second clocks respectively conforming to first and second standards which are mutually different in clock frequency, in bus arbitration, and in protocol type;
a transceiver integrated circuit from/to which first data conforming to said first standard propagate to/from an upper layer; and
a peripheral integrated circuit from/to which second data conforming to said second standard propagate to/from said transceiver integrated circuit.

2. The communication module according to claim 1, further comprising a data bus commonly used for propagating said first data and said second data.

3. The communication module according to claim 1, wherein said transceiver integrated circuit includes:
a first functional block for realizing an interface conforming to said first standard;
a second functional block for realizing an interface conforming to said second standard;
a clock pad connected to said clock bus;
a first clock line connected between said clock pad and said first functional block for propagating said first clock; and
a second clock line connected between said clock pad and said second functional block for propagating said second clock.

4. The communication module according to claim 2, wherein said transceiver integrated circuit includes:
a first functional block for realizing an interface conforming to said first standard;
a second functional block for realizing an interface conforming to said second standard;
a clock pad connected to said clock bus;
a data pad connected to said data bus;
a first clock line connected between said clock pad and said first functional block for propagating said first clock;
a second clock line connected between said clock pad and said second functional block for propagating said second clock;
a first data line connected between said data pad and said first functional block for propagating said first data; and
a second data line connected between said data pad and said second functional block for propagating said second data.

5. The communication module according to claim 1, wherein said transceiver integrated circuit includes:
a first functional block for realizing an interface conforming to said first standard;
a second functional block for realizing an interface conforming to said second standard;
a clock lead frame connected to said clock bus;
first and second clock pads;
a first clock line connected between said first clock pad and said first functional block for propagating said first clock;
a second clock line connected between said second clock pad and said second functional block for propagating said second clock;
a first wire for connecting said clock lead frame to said first clock pad; and
a second wire for connecting said clock lead frame to said second clock pad.

6. The communication module according to claim 2, wherein said transceiver integrated circuit includes:
a first functional block for realizing an interface conforming to said first standard;
a second functional block for realizing an interface conforming to said second standard;
a clock lead frame connected to said clock bus;
a data lead frame connected to said data bus;
first and second clock pads;
first and second data pads;
a first clock line connected between said first clock pad and said first functional block for propagating said first clock;
a second clock line connected between said second clock pad and said second functional block for propagating said second clock;
a first data line connected between said first data pad and said first functional block for propagating said first data;
a second data line connected between said second data pad and said second functional block for propagating said second data;
a first wire for connecting said clock lead frame to said first clock pad;
a second wire for connecting said clock lead frame to said second clock pad;
a third wire for connecting said data lead frame to said first data pad; and
a fourth wire for connecting said data lead frame to said second data pad.

7. The communication module according to claim 5, wherein
said clock lead frame has bifurcated tips,
said first wire connects one of said bifurcated tips of said clock lead frame to said first clock pad, and
said second wire connects the other of said bifurcated tips of said clock lead frame to said second clock pad.

8. The communication module according to claim 6, wherein
said clock lead frame has bifurcated tips,
said data lead frame has bifurcated tips,
said first wire connects one of said bifurcated tips of said clock lead frame to said first clock pad,
said second wire connects the other of said bifurcated tips of said clock lead frame to said second clock pad,
said third wire connects one of said bifurcated tips of said data lead frame to said first data pad, and
said fourth wire connects the other of said bifurcated tips of said data lead frame to said second data pad

9. A transceiver integrated circuit comprising:
first and second functional blocks for realizing interfaces respectively conforming to first and second standards which are mutually different in clock frequency, in bus arbitration, and in protocol type;
a clock pad;
a first clock line connected between said clock pad and said first functional block for propagating first clock conforming to said first standard; and
a second clock line connected between said clock pad and said second functional block for propagating second clock conforming to said second standard.

10. The transceiver integrated circuit according to claim 9, further comprising:
a data pad;
a first data line connected between said data pad and said first functional block for propagating first data conforming to said first standard; and
a second data line connected between said data pad and said second functional block for propagating second data conforming to said second standard.

11. A transceiver integrated circuit comprising:
first and second functional blocks for realizing interfaces respectively conforming to first and second standards which are mutually different in clock frequency, in bus arbitration, and in protocol type;
a clock lead frame;
first and second clock pads;
a first clock line connected between said first clock pad and said first functional block for propagating first clock conforming to said first standard;
a second clock line connected between said second clock pad and said second functional block for propagating second clock conforming to said second standard;
a first wire for connecting said clock lead frame to said first clock pad; and
a second wire for connecting said clock lead frame to said second clock pad.

12. The transceiver integrated circuit according to claim 11, further comprising:
a data lead frame;
first and second data pads;
a first data line connected between said first data pad and said first functional block for propagating first data conforming to said first standard;
a second data line connected between said second data pad and said second functional block for propagating second data conforming to said second standard;
a third wire for connecting said data lead frame to said first data pad; and
a fourth wire for connecting said data lead frame to said second data pad.

13. The transceiver integrated circuit according to claim 11, wherein
said clock lead frame has bifurcated tips,
said first wire connects one of said bifurcated tips of said clock lead frame to said first clock pad, and
said second wire connects the other of said bifurcated tips of said clock lead frame to said second clock pad.

14. The transceiver integrated circuit according to claim 12, wherein
said clock lead frame has bifurcated tips,
said data lead frame has bifurcated tips,
said first wire connects one of said bifurcated tips of said clock lead frame to said first clock pad,
said second wire connects the other of said bifurcated tips of said clock lead frame to said second clock pad,
said third wire connects one of said bifurcated tips of said data lead frame to said first data pad, and
said fourth wire connects the other of said bifurcated tips of said data lead frame to said second data pad.
